(19) United States
(12) Patent Application Publication
(10) Pub. No.: US 2016/0018230 A1
(43) Pub. Date: Jan. 21, 2016

(54) MULTIPLE DESTINATION VEHICLE INTERFACE

(71) Applicant: Ford Global Technologies, LLC, Dearborn, MI (US)

(72) Inventors: Cynthia M. Neubecker, Westland, MI (US); Nicholas Colella, Grosse Ile, MI (US)

(21) Appl. No.: 14/333,760

(22) Filed: Jul. 17, 2014

(51) Int. Cl. G01C 21/34

(52) U.S. Cl. CPC G01C 21/34

(57) ABSTRACT

A vehicle system includes a navigation engine, a communication interface, and a processing device. The communication interface receives a desired destination from a plurality of mobile devices. The processing device associates each desired destination with a priority, determines a destination order based on the associated priority and at least one predetermined factor, and commands the navigation engine to generate a route to each desired destination according to the destination order.

### BACKGROUND

Getting multiple passengers to unique destinations can be inefficient. Take busses, for example. The bus follows a predetermined route and stops at predetermined locations. Inefficiencies arise when nobody enters or leaves the bus at one of the stops. Also, the closest bus stop may be several blocks from the desired destination. More personalized transportation is not necessarily better when multiple destinations are involved. While a taxi, for instance, can take riders to different destinations, the best route to each destination is not always clear to the driver. That is, the driver may not be able to quickly determine the best route for taking each passenger to his or her respective destination. Further, passengers may disagree about which should be the first destination.

### BRIEF DESCRIPTION OF THE DRAWINGS

FIG. 1 illustrates an example vehicle having a system for developing efficient routes to multiple destinations.

FIG. 2 is a block diagram of an example system that may be incorporated into the vehicle of FIG. 1.

FIG. 3 is a flowchart of an example process that may be used develop efficient routes to multiple destinations.

### DETAILED DESCRIPTION

Taking passengers to different destinations can be made more efficient by having the vehicle optimize the route to each destination. The vehicle may include a system that considers factors such as reducing the total travel time, reducing the total travel distance, maximizing fuel economy, etc., when developing the optimized route. An example vehicle system includes a navigation engine, a communication interface, and a processing device. The communication interface may receive a desired destination from the mobile devices carried by the passengers. The processing device may associate each desired destination with a priority. The desired destinations may be ordered according to the priority and other factors such as those described above. The navigation engine may generate a route to each desired destination in the order determined by the processing device.

The vehicle and system shown may take many different forms and include multiple and/or alternate components and facilities. The exemplary components illustrated are not intended to be limiting. Indeed, additional or alternative components and/or implementations may be used.

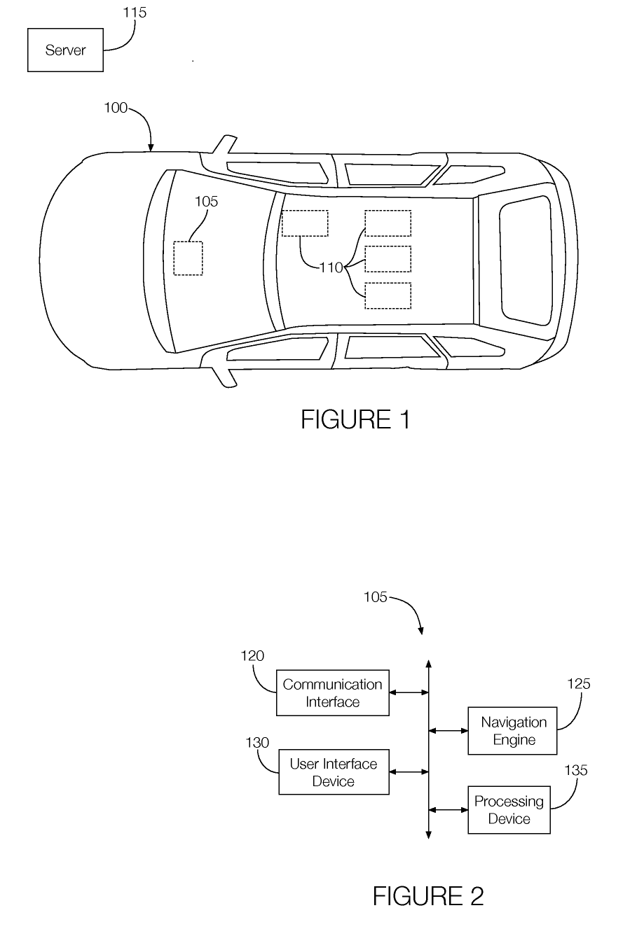

As illustrated in FIG. 1, the vehicle 100 includes a navigation system 105 configured to communicate with multiple mobile devices 110. Examples of mobile devices 110 may include mobile phones, tablet computers, laptop computers, and other electronic devices configured for wireless communication. Each mobile device 110 may be configured to pair with the navigation system 105, and vice versa. The navigation system 105 may be configured to communicate with the mobile devices 110 using a communication protocol such as Bluetooth® or Wi-Fi.

After communication has been established, the mobile devices 110 may be configured to transmit destination information to the navigation system 105. The destination information may include a desired destination selected by a user of the mobile device 110. The desired destination may include an address, latitude and longitude coordinates, intersection, or the like.

In some instances, the destination information is provided prior to the user entering the vehicle 100. For instance, the destination information may be provided via a user input to the mobile device 110 or another computing device and stored in a cloud-based server 115 configured to transmit the destination information to the navigation system 105 when mobile device 110 is in or near the vehicle 100. The cloud-based server 115 may store the destination information a profile database. The profile database may relate the user's name with common or user-provided destinations such as the user's home address, work address, recent destinations, or the like. New destinations may be received by the mobile device 110 or other computing device and stored in the profile database.

The navigation system 105 may be configured to generate a route to each destination. In generating the route, the navigation system 105 may consider factors such as reducing the total travel time, reducing the total travel distance, maximizing fuel economy, or the like. The navigation system 105 may be configured to consider traffic patterns when generating the route. When passenger are constantly entering and exiting the vehicle 100, which may occur with a bus, for instance, the navigation system 105 may further consider when the passenger entered the vehicle 100 relative to other passengers, giving a higher priority to passengers who entered the vehicle 100 first or who have been in the vehicle 100 the longest.

The navigation system 105 may be further configured to give preference to certain priority passengers. A passenger may purchase a priority pass. The destination information may indicate whether the user has purchased a priority pass. Moreover, the destination information may indicate the type of priority pass, including a one-time purchase or a subscription where every destination is a priority destination for a given amount of time (e.g., a week, a month, a year, etc.) or number of uses (e.g., 10 destinations, 20 destinations, etc.). The navigation system 105 may place destinations designated with a priority pass above destinations that have no such designation. In other words, the navigation system 105 may generate routes that generally direct the vehicle 100 to priority destinations ahead of non-priority destinations.

A priority destination may not always be prioritized ahead of all non-priority destinations. For instance, if the non-priority destination is very close to the vehicle's current location, the navigation system 105 may make the close non-priority destination the next stop along the route.

The navigation system 105 may be configured to continually update the route as new passengers enter the vehicle 100. Moreover, the route may be updated in response to real-time destination updates from passengers. For instance, when a new passenger enters the vehicle 100, or when a current passenger provides a new destination via a user input to his or her mobile device 110, the updated destination information may be transmitted to the navigation system 105. The navigation system 105 may update the current route to include the new destination given the factors (travel time, travel distance, fuel economy, priority, etc.) discussed above. The vehicle 100 may immediately begin embarking on the new route.

The navigation system 105 may be further configured to generate and transmit status messages. The status messages may be sent in response to predetermined events such as an approaching or arriving at a passenger's destination or the passenger exiting the vehicle 100. The status message may be sent via a communication protocol and may take the form of an email, text message, or the like. The destination information may identify the recipient of the status message by email address or mobile phone number, for instance. By way of example only, with this feature, a parent may be notified when a minor passenger reaches his or her destination and exits the vehicle 100. Thus, a parent may be notified when his or her child gets to school and is dropped off at the bus stop after school. Alternatively or in addition, a passenger may receive the status message shortly before the vehicle 100 reaches the passenger's destination as a reminder that the passenger is to depart.

Although illustrated as a sedan, the vehicle 100 may include any passenger or commercial vehicle such as a car, a truck, a sport utility vehicle, a van, a minivan, a taxi, a bus, etc. In some possible approaches, the vehicle 100 is an autonomous vehicle configured to operate in an autonomous (e.g., driverless) mode, a partially autonomous mode, and/or a non-autonomous mode.

FIG. 2 illustrates a block diagram of example components of the navigation system 105. The navigation system 105, as shown, includes a communication interface 120, a navigation engine 125, a user interface device 130, and a processing device 135.

The communication interface 120 may be configured to facilitate wired and/or wireless communication between the navigation system 105 and other devices such as the mobile devices 110, cloud-based server 115, or both. The communication interface 120 may be configured to receive messages from, and transmit messages to, a cellular provider's tower and the Telematics Service Delivery Network (SDN) associated with the vehicle 100 that, in turn, establishes communication with one or more mobile devices. Cellular communication to the telematics transceiver through the SDN may also be initiated from an internet connected device such as a PC, Laptop, Notebook, or WiFi connected phone. The communication interface 120 may also be configured to communicate directly from the vehicle 100 to the mobile devices 110 using any number of communication protocols such as Bluetooth®, Bluetooth® Low Energy, or Wi-Fi.

The navigation engine 125 may be configured to determine the current location of the vehicle 100. Using a Global Positioning System (GPS) receiver, the navigation engine 125 may be configured to triangulate the position of the vehicle 100 relative to satellites or terrestrial based transmitter towers. The navigation engine 125, therefore, may be configured for wireless communication alone or in concert with the communication interface 120. The navigation engine 125 may be further configured to develop routes to one or more destination, as well as display a map and present turn-by-turn driving directions to the selected destination via, e.g., the user interface device 130. In some instances, the navigation engine 125 may develop the route according to the factors discussed above. The order of the destinations may be designated by the processing device 135, as discussed below. The navigation engine 125, therefore, may be configured to receive a list of destinations from the processing device 135 and develop the route to the destinations in the designated order.

The user interface device 130 may be configured to present information to a user, such as a driver of the vehicle 100. In some instances, the user interface device 130 may be configured to receive user inputs. An example of a user input may include if the driver wishes to override the route, destinations, or order of destinations determined by the navigation system 105. The user interface device 130 may be configured to display the route via a map, turn-by-turn directions, or both. Moreover, the user interface device 130 may include audible and visual presentations of the route. In some possible approaches, the user interface device 130 may include a touch-sensitive display screen.

The processing device 135 may be configured to process signals output by the communication interface 120, navigation engine 125, and user interface device 130. The processing device 135 may be further configured to output command signals to those and possibly other elements of the navigation system 105. The processing device 135 may be configured to receive the destination information from each mobile device 110 in the vehicle 100. The processing device 135 may extract each passenger's desired destination and order the destinations according to various factors, discussed above. The processing device 135 may further determine which, if any, destinations are priority destinations in generating the order. The processing device 135 may send the order of the destinations to the navigation system 105 with a command to generate a route to each destination in the order provided.

The processing device 135 may be configured to process updated destinations received, e.g., after the route has been generated. Updated destinations may be from new passengers entering the vehicle 100 or from current passengers changing their previous destination. In response to receiving an updated destination, the processing device 135 may consider how to incorporate the updated destination into the remaining portion of the route. In the case of a new passenger, the processing device 135 may consider the updated destination in view of the current location of the vehicle 100 and remaining portion of the route. Keeping in mind the factors discussed above, including priority, the processing device 135 may determine where (relative to the other destinations) to adjust what remains of the route to include the updated destination. If a current passenger changes his or her destination, the processing device 135 may determine where to adjust the route to include the updated destination after removing the old destination (i.e., the one replaced by the updated destination). The processing device 135 may command the navigation engine 125 to generate a new route that considers the updated destination.

The processing device 135 may be configured to generate status messages. As discussed above, the status messages may indicate when a particular passenger has reached a particular destination or exited the vehicle 100. Alternatively or in addition, a passenger may receive the status message shortly before the vehicle 100 reaches the passenger's destination as a reminder that the passenger is to depart. The status messages may further confirm that the passenger's destination information has been received, incorporated into the route, or both. The processing device 135 may be configured to command the communication interface 120 to transmit the status messages.

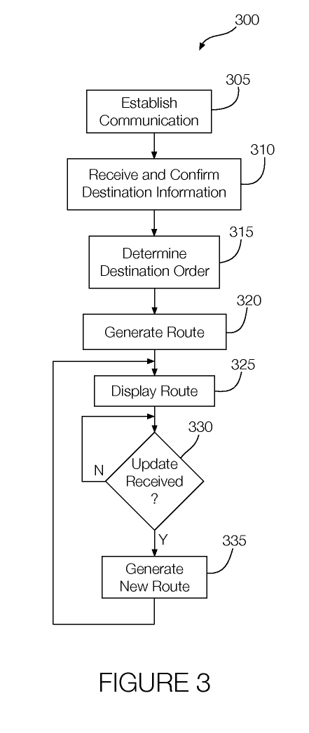

FIG. 3 is a flowchart of an example process 300 that may be implemented by one or more components of the navigation system 105.

At block 305, the navigation system 105 may establish communication with each mobile device 110 in the vehicle 100. As passengers enter the vehicle 100, the navigation system 105, through the communication interface 120, may attempt to pair with the mobile devices 110 carried by each passenger. As discussed above, the navigation system 105 may communicate using Bluetooth®, Wi-Fi, near-field communication (NFC), or any other telecommunication protocol. Pairing may occur automatically or may require some form of authentication. For instance, pairing may only occur after a passenger affirmatively acts to pair his or her mobile device 110 with the navigation system 105. In one possible approach, the passenger may give his or her consent to the pairing by entering a passcode into the mobile device 110.

At block 310, the navigation system 105 may receive and confirm destination information for each paired mobile device 110. To give the passengers peace of mind, the navigation system 105 may confirm that the destination information has been received and the destination incorporated into the route. The processing device 135, for instance, may generate such status messages and command the communication interface 120 to transmit the status messages to the respective mobile devices 110. Each mobile device 110 may receive confirmation that its destination information was received. If no destination information is received within a predetermined amount of time, the navigation system 105 may prompt any passenger, via his or her mobile device 110, to provide such information. For instance, the processing device 135 may generate a prompt and command the communication interface 120 to send the prompt to any mobile devices 110 that have not already sent destination information.

At block 315, the navigation system 105 may determine the order of the destinations. The navigation system 105 may consider the current location of the vehicle 100 relative to the locations of each destination. In general, the navigation system 105 may put the closest destination first along the route and the furthest last along the route. One exception to this general order may be if any of the destinations have priority status. In that case, priority destinations may be given priority over non-priority destinations. As discussed above, passengers may purchase priority.

At block 320, the navigation system 105 may generate the route to each destination considering factors such as minimizing travel time and distance, maximizing fuel economy, avoiding traffic backups, etc. In some instances, the entire route and list of destinations may be shared with each paired mobile device 110. Moreover, the navigation system 105 may transmit the estimated time to arrival to each destination, or for each particular passenger, to the mobile devices 110. Alternatively or in addition, as previously discussed, the navigation system 105 may send a status message shortly before the vehicle 100 reaches a passenger's destination as a reminder that the passenger is to depart.

At block 325, the navigation system 105 may display the route to the driver of the vehicle 100. The route may be displayed via, e.g., the user interface device 130. Moreover, the navigation system 105 may output audible or visual turn-by-turn directions. Where the vehicle 100 is operated autonomously, the route and turn-by-turn directions may be presented for the passengers' benefits. When the vehicle 100 reaches each destination, the navigation system 105 may generate and transmit a status message as previously discussed. The status message may inform a parent that his or her child has reached his or her destination and has exited the vehicle 100. Other status messages may notify a parent that his or her child has arrived at school or was dropped off at the bus stop after school.

At decision block 330, the navigation system 105 may determine whether any new or updated destinations have been received. As the vehicle 100 travels the route, the navigation system 105 may monitor passenger ingress and egress. Ingress may be monitored by looking for new mobile devices 110 that have entered the vehicle. Egress may be monitored by noting when a mobile device 110 is no longer paired with the navigation system 105, which may indicate that the mobile device 110 is no longer in the vehicle. Therefore, the updated destinations may be received when, e.g., a new passenger enters the vehicle 100, a passenger leaving the vehicle 100 at a different stop than indicated by the destination information, or in response to a passenger changing his or her desired destination in real-time. If a new or updated destination has been received, the process 300 may continue at block 335. Otherwise, block 330 may be repeated until an updated destination is received, the route generated at block 320 is completed or otherwise canceled, or the vehicle 100 is turned off

At block 335, the navigation system 105 may generate a new route that includes the updated destination received at block 330. As discussed above, this may include adding the updated destination to what remains of route generated at block 320, deleting an old destination (i.e., the one replaced by the updated destination), or both. The process 300 may return to block 325 after the route has been updated.

In general, computing systems and/or devices discussed above may employ any of a number of computer operating systems, including, but by no means limited to, versions and/or varieties of the Ford Sync® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OS X and iOS operating systems distributed by Apple Inc. of Cupertino, California, the BlackBerry OS distributed by Research In Motion of Waterloo, Canada, and the Android operating system developed by the Open Handset Alliance. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle system comprising:
a navigation engine;
a communication interface configured to receive a desired destination from a plurality of mobile devices, wherein each mobile device is associated with a passenger and wherein the communication interface is programmed to receive the desired destination when the passenger associated with the mobile device enters a host vehicle; and
a processing device programmed to associate each desired destination with a priority, determine a destination order based at least in part on the associated priority and at least one predetermined factor, and command the navigation engine to generate a route to each desired destination according to the destination order, wherein the processing device is programmed to command the navigation engine to generate the route to each desired destination each time at least one passenger enters the host vehicle.

2. The vehicle system of claim 1 wherein the navigation engine is configured to generate the route according to the destination order.

3. The vehicle system of claim 1 wherein the at least one predetermined factor includes at least one of a minimum travel time, a minimum travel distance, and maximizing fuel economy based at least in part on the desired destinations of passengers presently in the host vehicle.

4. The vehicle system of claim 1 wherein the communication interface is configured to receive destination information from each of the plurality of mobile devices, the destination information including the desired destination.

5. The vehicle system of claim 4 wherein the processing device is configured to extract the desired destination from the destination information.

6. The vehicle system of claim 4 wherein the processing device is configured to extract the priority from the destination information.

7. The vehicle system of claim 4 wherein the processing device is configured to determine the priority from a remote server.

8. The vehicle system of claim 1 wherein the communication interface is configured to receive an updated destination each time at least one passenger enters the host vehicle.

9. The vehicle system of claim 8 wherein the processing device is configured to command the navigation engine to incorporate the updated destination into the route each time at least one passenger enters the host vehicle.

10. The vehicle system of claim 9 wherein the processing device is configured to update the destination order to include the updated destination each time at least one passenger enters the host vehicle.

11. The vehicle system of claim 9 wherein the navigation engine is configured to update the route to include the updated destination.

12. The vehicle system of claim 1 wherein the processing device is configured to generate a status message.

13. The vehicle system of claim 12 wherein the processing device is configured to command the communication interface to send the status message.

14. A vehicle system comprising:
a navigation engine configured to generate a route;
a communication interface configured to receive a desired destination from a plurality of mobile devices, wherein each mobile device is associated with a passenger and wherein the communication interface is programmed to receive the desired destination when the passenger associated with the mobile device enters the host vehicle; and
a processing device programmed to associate each desired destination with a priority, determine a destination order based at least in part on the associated priority and at least one predetermined factor, and command the navigation engine to generate a route to each desired destination according to the destination order, wherein the processing device is programmed to command the navigation engine to generate the route to each desired destination each time at least one passenger enters the host vehicle,
wherein the communication interface is configured to receive an updated destination after the route has been generated each time at least one passenger enters the host vehicle, and
wherein the processing device is configured to generate a status message and command the communication interface to transmit the status message.

15. The vehicle system of claim 14 wherein the processing device is configured to update the destination order to include the updated destination and command the navigation engine to incorporate the updated destination into the route each time at least one passenger enters the host vehicle.

16. The vehicle system of claim 14 wherein the at least one predetermined factor includes at least one of a minimum travel time, a minimum travel distance, and maximizing fuel economy each time at least one passenger enters the host vehicle.

17. A method comprising:
receiving a plurality of desired destinations from a plurality of mobile devices, wherein the desired destination is received each time a passenger associated with one of the plurality of mobile devices enters a host vehicle;
associating each desired destination to a priority;
determining, each time at least one passenger enters the host vehicle, a destination order based at least in part on the associated priority and at least one predetermined factor; and
commanding a navigation engine to generate a route to each desired destination according to the destination order each time at least one passenger enters the host vehicle.

18. The method of claim 17 further comprising:
receiving an updated destination each time at least one passenger enters the host vehicle;
updating the destination order to include the updated destination; and
commanding the navigation engine to incorporate the updated destination into the route.

19. The method of claim 17 further comprising generating a status message.

20. The method of claim 19 further comprising sending the status message to at least one of the mobile devices.
